(19) United States
(12) Patent Application Publication
(10) Pub. No.: US 2009/0324373 A1
(43) Pub. Date: Dec. 31, 2009

(54) Vehicle Carrier Device

(76) Inventor: Peter Campbell, Thunder Bay (CA)

Correspondence Address: ADE & COMPANY INC., 2157 Henderson Highway, WINNIPEG, MB, R2G1P9, CA

(21) Appl. No.: 12/463,041

(22) Filed: May 8, 2009

Related U.S. Application Data
(60) Provisional application No. 61/075,770, filed on Jun. 26, 2008.

(51) Int. Cl. B60P 7/06

(52) U.S. Cl. 414/462

(57) ABSTRACT

A carrier device supports a personal all terrain vehicle (ATV) in a truck bed of a truck so that the ATV can be supported at an incline within the truck box and the tailgate of the truck box can still be closed even on shorter length boxes to reduce wear on the tailgate during transport, and to reduce the wind resistance during transport as compared to carrier devices which support the ATV above the side walls of the truck bed. The carrier device comprises a frame mounted in the truck bed to support the ATV thereon in an inclined position extending at a forward and upward incline from a rear end to a front end of the bed. By supporting the rear end of the ATV adjacent the floor of the truck bed, loading ramps are only required to extend from the ground to the height of the floor of the truck box.

This application claims the benefit under 35 U.S.C. 119(e) of U.S. provisional application Ser. No. 61/075,770, filed Jun. 26, 2008.

### FIELD OF THE INVENTION

The present invention relates to a carrier device for supporting a personal all terrain vehicle in the truck bed of a truck, and more particularly the present invention relates to a vehicle carrier device in which the all terrain vehicle is arranged to be supported at an upward incline such that the tailgate of a short truck bed can be closed when the all terrain vehicle is supported in the truck bed.

### BACKGROUND

Loading and transporting personal all terrain vehicles in trucks is known to be desirable for transporting all terrain vehicles to remote locations, for example for recreation, hunting, or fishing, etc. A common design of many trucks includes a large cab which reduces the length of the storage box or bed at the rear of the truck so that the box is commonly shorter than the overall length of the all terrain vehicle. In this instance, a tailgate at the rear of the truck box is required to remain open when an all terrain vehicle is received in the box. This arrangement places considerable strain on the tailgate during transport due to the mass of the all terrain vehicle and/or the gate which may be subject to some bouncing movement during transport causing unnecessary wear on the hinges of the tailgate which may damage the vehicle.

U.S. Pat. Nos. 5,553,762 belonging to Brown and 4,874,284 belonging to New Jr. disclose devices for carrying all terrain vehicles on a truck bed in which a platform is supported above the side walls of the truck bed to permit the tailgate to remain closed when all terrain vehicles are supported thereon. Due to the platform being fully supported above the side walls of the box, very large loading ramps are required to load the all terrain vehicles up to the full height of the side walls of the truck box. Once loaded, the all terrain vehicles are fully supported above the side walls so as to result in a very high center of gravity of the load which is unstable and has a very high wind resistance during transport.

U.S. Pat. No. 6,705,820 belonging to Schilling discloses a further example of an all terrain vehicle carrier for a truck box in which a platform is again fully supported above a height of the side walls of the truck box to permit closing of the tailgate in transport, however to reduce the size of the loading ramps required from the ground to the platform, the platform can be lowered when the tailgate is open to a loading position extending downwardly and rearwardly through the tailgate opening. Accordingly the tailgate is required to be open when the platform is in the inclined loading position. In order to close the tailgate, the platform must be lifted to the transport position above the side walls of the deck so that the all terrain vehicle has a very high center of gravity relative to the truck so as to be unstable and provide a high wind resistance during transport as in the examples noted above.

### SUMMARY OF THE INVENTION

According to one aspect of the invention there is provided a vehicle carrier device for supporting a personal all terrain vehicle on a truck comprising a truck bed having a pair of side walls and a rear tailgate supported at a rear of the truck bed for pivotal movement between an open position and a closed position spanning the side walls, the vehicle carrier device comprising a frame arranged to be mounted in the truck bed and arranged to support the all terrain vehicle thereon in an inclined position extending at an upward incline from one end of the all terrain vehicle to the other end of the all terrain vehicle such that the rear tailgate is arranged to be closed in the inclined position of the all terrain vehicle.

By providing a frame including a ramp which can be fixedly supported within the truck box so that an all terrain vehicle can be supported at an incline within the truck box, the tailgate of the truck box can still be closed even on shorter length boxes to reduce wear and damage to the truck at the tailgate during transport while still permitting a significant portion of the all terrain vehicle to be received downwardly into the truck box below the side walls of the box so as to lower the center of gravity relative to the prior patents noted above as well as reducing the wind resistance during transport.

Furthermore, the fixed construction of the ramp received within the truck box is of low cost to manufacture and maintain as compared to the complex lifting linkage required by Schilling in the prior art noted above. By supporting the rear end of the all terrain vehicle adjacent the floor of the truck box while still permitting the tailgate to be closed, loading ramps are only required to extend from the ground to the height of the floor of the truck box so that the auxiliary ramps for loading are also smaller and of lower cost than that which would be required for lifting an all terrain vehicle onto a platform fully above the side walls of the truck box as in the prior art examples noted above.

The frame may comprise a first portion arranged to support a pair of wheels at one end of the all terrain vehicle thereon and a second portion arranged to support a pair of wheels at the other end of the all terrain vehicle thereon in which the first portion of the frame is higher in elevation than the second portion.

The frame may be arranged to support an end of the all terrain vehicle adjacent a front end of the truck bed higher in elevation than an end of the all terrain vehicle adjacent a rear end of the truck bed.

When the frame includes a front portion arranged to support an end of the all terrain vehicle adjacent a front end of the truck bed thereon, the front portion of the frame is preferably arranged to be supported in the truck bed substantially at a height of the side walls.

The frame is preferably arranged to support an end of the all terrain vehicle at a rear end of the truck bed adjacent a floor of the truck bed.

The frame may include an inclined ramp portion arranged to be supported in the truck bed in fixed orientation relative to the truck bed.

When the frame includes a front portion arranged to support an end of the all terrain vehicle adjacent a front end of the truck bed thereon, the frame preferably further comprises an inclined ramp portion extending downwardly and rearwardly from the front portion to a rear portion arranged to be supported adjacent a floor of the truck bed.

The front portion may extend generally horizontally forward from a front end of the inclined ramp portion such that the front portion is arranged to support front wheels of the all terrain vehicle thereon.

The front portion may further be arranged to span forwardly from a front end of the inclined ramp portion a distance which is near a diameter of a wheel of the all terrain vehicle.

The inclined ramp portion preferably has a length which is less than a distance between front and rear wheels of the all terrain vehicle.

When provided in combination with a window guard device comprising rigid protective members arranged to span a rear window of the truck, the front portion of the frame which is arranged to support an end of the all terrain vehicle adjacent a front end of the truck bed thereon may be arranged to be supported on the window guard device.

When provided in combination with a truck bed ramp arranged to provide access of the all terrain vehicle to the truck bed from the ground, the frame is preferably arranged to support the all terrain vehicle in the truck bed such that the truck bed ramp is arranged to be received in the truck bed below the all terrain vehicle.

The frame preferably comprises two frame portions arranged to be supported parallel and spaced apart from one another in the truck box in which each frame portion comprises a front wheel portion arranged to support a respective one of the front wheels thereon, a rear wheel portion arranged to support a respective one of the rear wheels thereon and an inclined ramp portion extending at an upward and forward incline from the rear wheel portion to the front wheel portion. When provided in combination with the truck bed ramp arranged to provide access of the all terrain vehicle to the truck bed from the ground, the two frame portions are preferably spaced apart such that the truck bed ramp is arranged to be received between the two frame portions.

There may be provided at least one rear panel member pivotally mounted on a rear end of the frame for pivotal movement between a loading position arranged to lay substantially flat against a floor of the truck bed and a transport position in which the rear panel member is arranged to extend upwardly rearwardly from a portion of at least one of the rear wheels of the all terrain vehicle.

A leg member may be pivotally coupled to said at least one rear panel member in which the leg member is arranged to extend downwardly from a free end of the rear panel member so as to be arranged to support the free end of the rear panel member spaced above the floor of the truck bed in the transport position.

There may be provided a link member arranged to be coupled between a free end of said at least one rear panel member and the frame at a location spaced forwardly of the rear panel member so as to be arranged to support the free end of the rear panel member spaced above the floor of the truck bed in the transport position.

There may also be provided a handle member pivotally coupled to said at least one rear panel member in which the handle member is pivotal between the loading position in which the handle member is arranged to lay substantially flat against the rear panel member and a lifting position in which the handle member is arranged to extend outwardly from the rear panel member so as to be arranged for gripping by a hand of a person.

When provided in combination with a truck bed which is shorter in length between a front end and a rear end thereof than the all terrain vehicle, the rear tailgate of the truck bed is still arranged to be closed in the inclined position of the all terrain vehicle.

One embodiment of the invention will now be described in conjunction with the accompanying drawings in which:

### BRIEF DESCRIPTION OF THE DRAWINGS

FIG. 1 is a perspective view of the carrier device shown schematically supported in a truck box.

FIG. 2 is a schematic side elevational view of the carrier device in a transport position.

FIG. 3 is a schematic side elevational view of the carrier device in a loading position.

FIG. 4 is a rear elevational view of the carrier device shown supported in the truck box in the loading position.

FIG. 5 is a top plan view of the carrier device shown supported in the truck box.

FIG. 6 is a perspective view of one of the frame portions of the carrier device in the loading position.

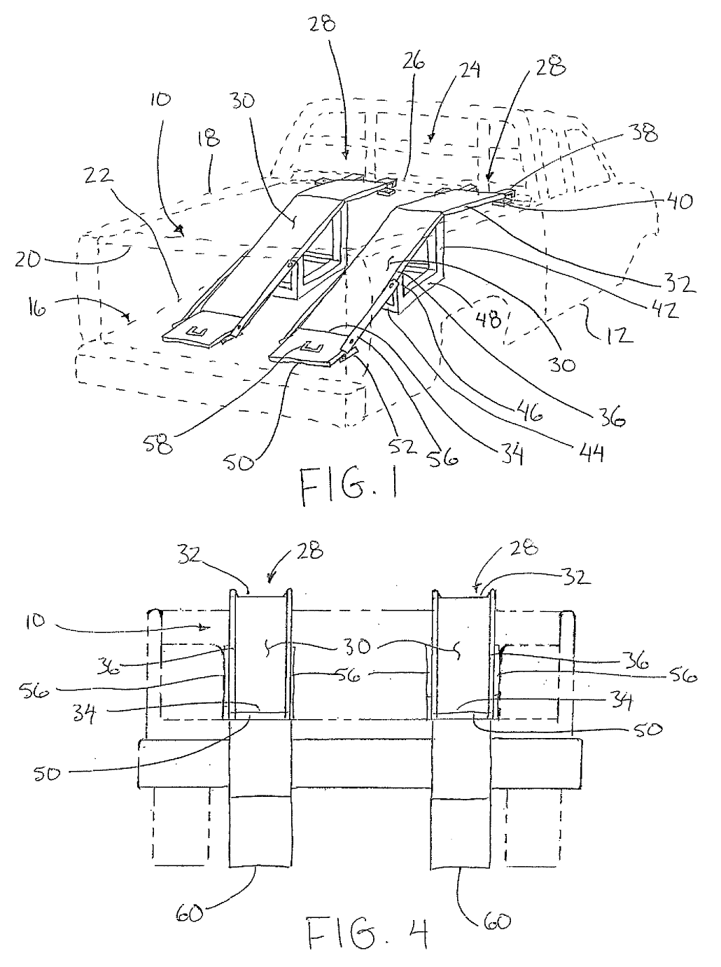

In the drawings like characters of reference indicate corresponding parts in the different figures.

### DETAILED DESCRIPTION

Referring to the accompanying figures there is illustrated a vehicle carrier device generally indicated by reference numeral 10. The device 10 is particularly suited for use with a truck 12 for supporting a personal all terrain vehicle or ATV 14 on the truck.

The truck 12 typically comprises a rear truck box or truck bed 16 having a pair of side walls 18 extending along opposing sides of the box parallel and spaced apart from one another from a front end adjacent a cab of the truck to a rear end at a tailgate opening of the box. A suitable tailgate 20 is pivotally coupled to the side walls 18 adjacent the floor 22 of the truck box so as to be hinged for movement between an open position extending rearwardly from the box substantially level with the floor 22 of the box and a closed position extending upright and spanning across the tailgate opening between the side walls 18.

The vehicle carrier device 10 is suited for loading and carrying an ATV 14 of the type comprising a personal four wheel ATV which is longer between the front wheels and rear wheels thereof than a typical shorter length truck box. The device 10 is suited for supporting the ATV 14 within the truck box at an upward incline from one end of the vehicle to the other so that the tailgate can be closed with the vehicle received within the truck box even when the vehicle is longer from front to rear than the truck box when supported on level ground.

A portion of the device 10 may be supported on a window guard device 24 supported on the truck. The window guard device typically comprises a plurality of rigid protective members 26 which span horizontally across the rear window of the truck cab at vertically spaced positions and which are joined by upright auxiliary members to define a rigid frame lying generally in a vertical plane spanning the rear window to protect the occupants in the truck cab from cargo in the truck box thrown forwardly, for example during a vehicular collision. A lowermost one of the rigid members 26 spans across the width of the truck box to be supported at respective opposing ends on top of the two side walls 18 of the truck box at the forward end thereof.

The vehicle carrier device 10 comprises a frame which is arranged to be substantially fixed mounted within the truck box. The frame includes two frame portions 28 extending along respective sides of the truck box at parallel and spaced apart positions so that each frame portion spans the length of the truck box from the forward end to the rearward end thereof. Each frame portion includes an upper supporting surface 30 which is wider in a lateral direction than the width of the wheels and which spans substantially the length of the truck box to allow rolling movement of the wheels of the ATV therealong during loading and unloading.

The upper supporting surface 30 is generally rigid and is formed to provide suitable gripping texture for gripping by the wheels of the all terrain vehicle rolling therealong. In one embodiment the upper surface of each frame portion comprises two side members extending the length of the surface and interconnected by a plurality of longitudinally spaced bars which are connected in a lateral direction between the two side members. Alternatively the supporting surfaces 30 may comprise a continuous surface or various other combinations of grates or grills which are suitable for supporting the weight of the all terrain vehicle thereon.

Each frame portion 28 includes a first front wheel portion 32 arranged to support a respective one of the front wheels of the all terrain vehicle thereon, a second rear wheel portion 34 arranged to support a respective one of the rear wheels of the all terrain vehicle thereon and an inclined ramp portion 36 extending at an upward and forward incline from the rear wheel portion 34 to the front wheel portion 32 which is higher in elevation than the rear wheel portion.

The front wheel portion 32 is arranged to extend generally horizontally forward from the inclined ramp portion 36 a length which corresponds approximately to a diameter of the wheel supported thereon. A hook member 38 is supported at the forward end on both lateral sides of each front wheel portion 32 and includes a first portion extending forwardly from the front wheel portion and a depending portion extending downward from the forward end of the first portion so as to be arrange for overlapping a top side and extending downwardly over the front side of the lowermost one of the rigid members 26 of the window guard device 24 spanning across the truck box between forward top ends of the side walls.

A generally horizontal fastener flange 40 also projects outwardly from each front wheel portion at both sides of the forward end thereof for overlapping a cooperating fastener flange on the rigid member of the window guard device 24 for receiving a suitable threaded fastener bolted through cooperating apertures in the fastener flanges 40 to further retain the forward ends of the front wheel portions fixed relative to the truck box by fastening to the rigid window guard device 24.

The horizontal configuration of the front wheel portions 32 supported on the window guard device 24 are arranged to fully support the respective front wheels of the all terrain vehicle thereon just above the height of the side walls such that the front wheel portions 32 are located substantially at the height of the side walls with the front wheels thereabove in the transport position. The front ends of the front wheel portions 32 of the frame portions are arranged to abut the rear side of the window guard device when the depending portions of the hook members 38 overlap overtop and downwardly over the front side of the window guard device to assist in aligning the cooperating apertures in the fastener flanges 40 during assembly and mounting onto the truck box.

A rear end of the front wheel portions 32 are each supported by a respective pair of front legs 42 extending downwardly from the front wheel portion to the floor of the truck box. The front legs associated with each frame portion are joined with one another by a suitable rigid frame member at the floor of the truck box to maintain the front legs 42 in a suitable vertical orientation spanning between the floor and the front wheel portions 32 thereabove. The pair of front legs 42 associated with each frame portion extend downwardly from opposing sides of the respective front wheel portion.

The inclined ramp portion 36 of each frame portion 28 extends downwardly and rearwardly from the respective front wheel portion 32 to the respective rear wheel portion 34 located substantially at or adjacent the floor of the truck box. The length of the ramp portion 36 corresponds approximately near, but preferably slightly less than the length of the wheel base of the ATV from the front wheels to the rear wheels thereof so that when the front wheels of the all terrain vehicle are supported on the front wheel portions 32 at the front end of the ramp portions, the rear wheels are supported at the respective rear wheel portions 34 of the frame portions corresponding to the rear ends of the respective ramp portions 36.

The ramp portions 36 are fixed in orientation relative to the deck by intermediate legs 46 supporting a central portion of each inclined ramp portion at a location spaced above the floor of the truck box. A pair of the intermediate legs 46 is associated with each inclined ramp portion so as to extend vertically downward from opposing sides of the ramp portion at a central location spaced between the front and rear ends thereof. Auxiliary floor members 48 comprising rigid frame members similar to the members 44 are connected laterally between each pair of the intermediate legs 46 at the bottom end thereof adjacent the floor of the truck box to maintain the intermediate legs in a vertical orientation. Additional floor members 48 extend in the longitudinal direction between the bottom of each intermediate leg 46 and the corresponding front leg 42 spaced forwardly therefrom to maintain the ramp portions in a fixed orientation relative to the truck box.

Each rear wheel portion 34 of the frame portions of the device 10 is located adjacent the floor of the truck box at the rear end of the corresponding ramp portion 36 for supporting a respective one of the rear wheels of the ATV thereon when the front wheels are supported on the front wheel portions 32.

Each rear wheel portion includes a rear panel member 50 which is arranged to be positioned rearwardly of at least a portion of the rear wheels of the ATV when the front wheels are supported on the respective front wheel portions to assist in retaining the ATV in a transport position on the frame of the device. Each rear panel member 50 is hinged at the rear end of the ramp portions 36 respectively for pivotal movement between a loading position in which the rear panel member 50 lays substantially flat against the floor of the truck box to extend rearwardly substantially horizontally from the rear end of the ramp portion to permit rolling of the wheels of the ATV over the rear panel members during loading, and a transport position in which the rear panel member 50 of each frame portion extends at an upward and rearward incline immediately rearward of a portion of the respective rear wheels supported thereabove. The upward inclination of the rear panel member behind a portion of each rear wheel of the ATV in the loaded transport portion serves to resist rearward rolling movement of the ATV from the transport position to retain the ATV in the transport position.

To support the rear panel members 50 in the transport position, each rear panel member includes a pair of rear leg members 52 pivotally coupled to opposing sides of the rear panel member adjacent the rear free edge thereof. In the loading position of the rear panel members, the rear leg members are arranged to extend downwardly in a vertical orientation to engage the floor of the truck box and maintain the rear free edge of the panel supported spaced above the floor of the truck box. The rear leg members 52 of each rear panel are pivotally coupled at the top ends thereof to the respective sides of the rear panel member and are joined with one another at the bottom ends thereof by a suitable foot member 54 spanning laterally therebetween so that the leg members 52 can be pivoted together between the loading position extending vertically downward to support the rear panel members spaced above the floor and a loading position in which the leg members can be extended forwardly along opposing sides of the rear panel member to lay substantially flat against the floor of the truck box with the foot member 54 being received between the bottom side of the rear panel member and the floor of the truck box against which it lays.

To provide additional support to maintain the rear panel members in the transport position, there is provided a pair of link members 56 associated with each rear panel member 50. The link members of each rear panel member are pivotally supported at respective front ends to the opposing sides of the inclined ramp portion at the location of the intermediate legs 46 respectively. The rear ends of the link members 56 are arranged to be selectively pinned for connection to the rear free edge of the respective rear panel member 50 at opposing sides thereof at the pivotal connection of the leg members 52 respectively.

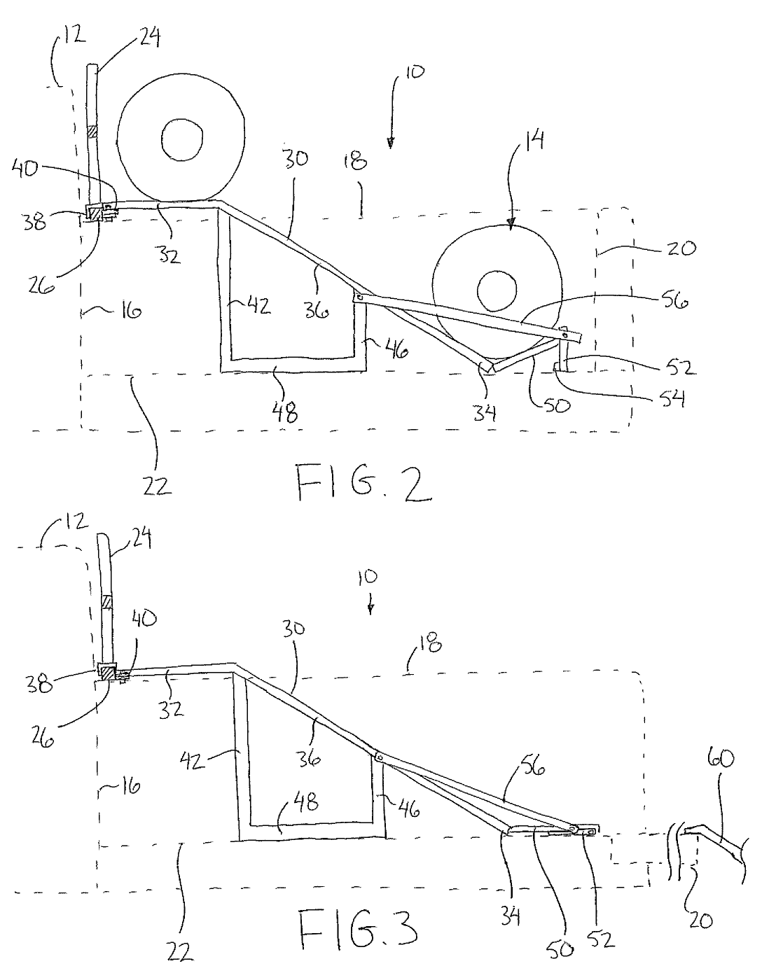

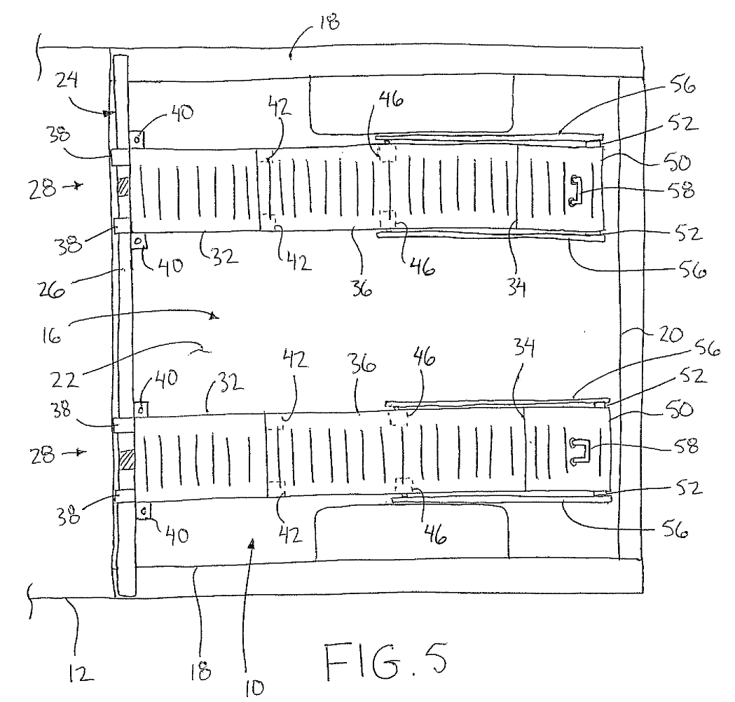

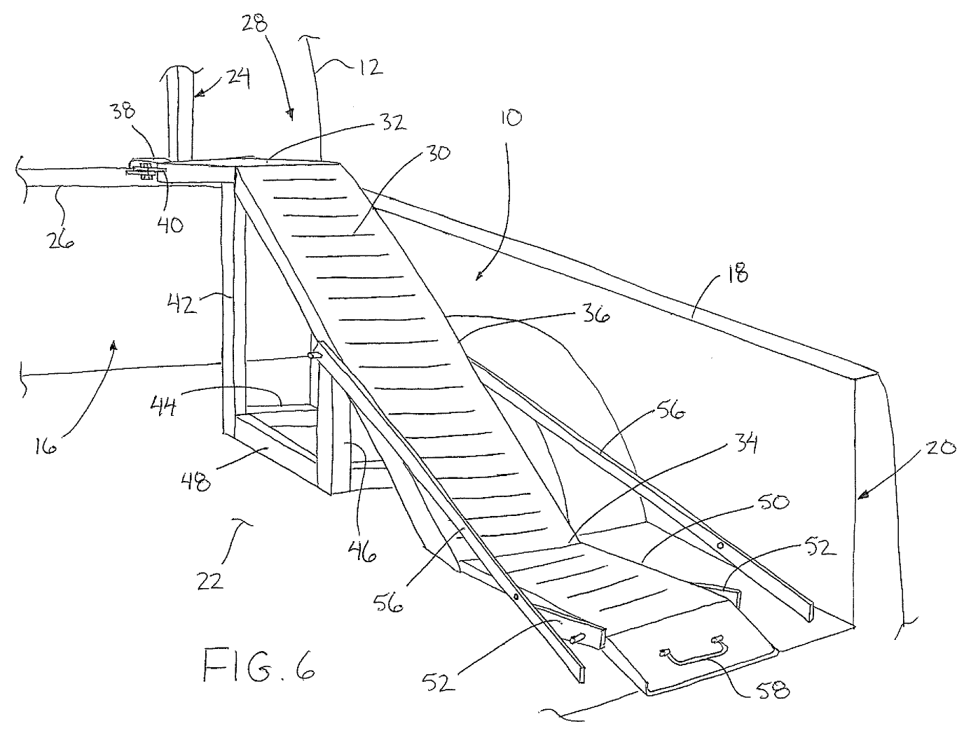

In the loading position, the rear ends of the link members 56 are selectively pinned to the rear free edge of the respective rear panel member 50 along opposing sides of the respective rear wheels supported thereabove so that the link members 56 and the rear leg members 52 together can support the weight of the rear end of the ATV engaged on the upward and rearward inclination of the rear panel members to be prevented from rear rolling movement away from the transport position of FIG. 2.

In the loading position, the rear ends of the link members 56 are released from the rear panel members 50 and the bottom ends of the leg members are pivoted forwardly beneath the rear panel members 50 so that the rear panel members can be laid substantially against the floor of the truck box to permit rolling of the wheels of the all terrain vehicle over the rear panel members. In the transport position, the link members and the leg members together support the free end of the rear panel spaced above the floor of the truck bed such that the panel member extends upwardly at a location which is rearward from a portion of the rear wheels respectively.

Each rear panel member 50 includes a handle member 58 which is pivotally coupled to a top side of the rear panel member at a central location spaced between the front and rear ends and between opposing side thereof. The handle member is a generally U-shaped member including a central portion arranged to be gripped by a hand of a user and a pair of end portions spanning between the central portion and respective pivotal connections to the surface of the rear panel member. The pivotal connection of the handle member of each rear panel member permits the handle member to be pivoted between a lifting position in which the handle member extends outwardly from the rear panel member so that the central portion thereof is spaced from the rear panel so as to be arranged for gripping by a hand of a person and a loading position in which the handle member is arranged to lay substantially flat against the rear panel member so that the wheels of the ATV can readily roll over the handle member when rolling across the respective frame portions between the loading and transport positions.

The device 10 is also used with a pair of auxiliary loading ramps 60 which are arranged to be aligned with the two frame portions of the device 10 respectively. The two ramps 60 have a suitable length to permit loading from the ground to the floor of the truck box by attachment to the top rear edge of the tailgate when the tailgate is in the open position. The ramps 60 are arranged to be foldable into a storage position in which the ramps 60 are arranged to be received on the floor of the truck bed between the two frame portions of the device 10 due to the space provided therebetween. Accordingly the ramps 60 are arranged to be received beneath the ATV when the ATV is stored on the two frame portions in the transport position.

In use, auxiliary ramps 60 of various configurations are provided for loading the all terrain vehicle from the ground into the truck box when the tailgate is open. The two frame portions of the device 10 are supported at a fixed orientation within the truck box with the inclined ramp portions being arranged to remain at an upward and forward incline so that the front wheels at the front end of the all terrain vehicle are automatically raised as they are driven forwardly along the two frame portions of the device upon entering the truck box of the truck during loading.

Once the front wheels of the all terrain vehicle are positioned on the respective front wheel portions 32 of the device and the rear wheels are positioned at the rear wheel portions 34, the rear wheels are arranged to be supported substantially at the floor of the truck box ahead of the tailgate opening so that the tailgate can be fully closed during transport in the transport position of the device.

In the transport position the rear panel members are raised and secured by the leg members 52 and link members 56 as described above to suitably retain the ATV loaded on the frame portions of the device. Suitable strapping is used to fix the ATV in the truck box for transport with the frame of the device 10 supporting the front end of the ATV adjacent the front end of the truck bed higher in elevation at the height of the side walls than the rear end of the ATV at the rear end of the truck bed which is substantially adjacent the floor of the truck bed.

Accordingly the ATV remains fixed at an upward and forward incline in the transport position so that an ATV having a wheel base which is longer than a short box truck can still be received within the box with the tailgate closed and loading ramps for loading the ATV from the ground to the floor of the truck bed can be received below the ATV between the two frame portions of the device 10. The resulting position of the ATV in the transport position has a low centre of gravity so as to be more stable and have lower wind resistance during transport as compared to prior art configurations in which the ATV is fully supported above the height of the side walls of the truck box during transport.

When unloading, the tailgate of the truck box is opened and the auxiliary ramps 60 are assembled from the floor of the truck box to the ground. Displacing the rear panel members 50 to the loading position permits the ATV to be simply driven rearwardly down the inclined ramp portion of the device 10 and the auxiliary ramps 60 to the ground.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A vehicle carrier device for supporting a personal all terrain vehicle on a truck comprising a truck bed having a pair of side walls and a rear tailgate supported at a rear of the truck bed for pivotal movement between an open position and a closed position spanning the side walls, the vehicle carrier device comprising a frame arranged to be mounted in the truck bed and arranged to support the all terrain vehicle thereon in an inclined position extending at an upward incline from one end of the all terrain vehicle to the other end of the all terrain vehicle such that the rear tailgate is arranged to be closed in the inclined position of the all terrain vehicle.

2. The device according to claim 1 wherein the frame comprises a first portion arranged to support a pair of wheels at one end of the all terrain vehicle thereon and a second portion arranged to support a pair of wheels at the other end of the all terrain vehicle thereon, the first portion of the frame being higher in elevation than the second portion.

3. The device according to claim 1 wherein the frame is arranged to support an end of the all terrain vehicle adjacent a front end of the truck bed higher in elevation than an end of the all terrain vehicle adjacent a rear end of the truck bed.

4. The device according to claim 1 wherein the frame includes a front portion arranged to support an end of the all terrain vehicle adjacent a front end of the truck bed thereon, the front portion of the frame being arranged to be supported in the truck bed substantially at a height of the side walls.

5. The device according to claim 1 wherein the frame is arranged to support an end of the all terrain vehicle at a rear end of the truck bed adjacent a floor of the truck bed.

6. The device according to claim 1 wherein the frame includes an inclined ramp portion arranged to be supported in the truck bed in fixed orientation relative to the truck bed.

7. The device according to claim 1 wherein the frame includes a front portion arranged to support an end of the all terrain vehicle adjacent a front end of the truck bed thereon and an inclined ramp portion extending downwardly and rearwardly from the front portion to a rear portion arranged to be supported adjacent a floor of the truck bed.

8. The device according to claim 7 wherein the front portion extends generally horizontally forward from a front end of the inclined ramp portion, the front portion being arranged to support front wheels of the all terrain vehicle thereon.

9. The device according to claim 7 wherein the front portion is arranged to span forwardly from a front end of the inclined ramp portion a distance which is near a diameter of a wheel of the all terrain vehicle.

10. The device according to claim 7 wherein the inclined ramp portion is arranged to have a length which is less than a distance between front and rear wheels of the all terrain vehicle.

11. The device according to claim 1 in combination with a window guard device comprising rigid protective members arranged to span a rear window of the truck, wherein the frame includes a front portion arranged to support an end of the all terrain vehicle adjacent a front end of the truck bed thereon and the front portion is arranged to be supported on the window guard device.

12. The device according to claim 1 in combination with a truck bed ramp arranged to provide access of the all terrain vehicle to the truck bed from the ground, the frame being arranged to support the all terrain vehicle in the truck bed such that the truck bed ramp is arranged to be received in the truck bed below the all terrain vehicle.

13. The device according to claim 1 wherein the frame comprises two frame portions arranged to be supported parallel and spaced apart from one another in the truck box, each frame portion comprises a front wheel portion arranged to support a respective one of the front wheels thereon, a rear wheel portion arranged to support a respective one of the rear wheels thereon and an inclined ramp portion extending at an upward and forward incline from the rear wheel portion to the front wheel portion.

14. The device according to claim 13 in combination with a truck bed ramp arranged to provide access of the all terrain vehicle to the truck bed from the ground, the two frame portions being spaced apart such that the truck bed ramp is arranged to be received between the two frame portions.

15. The device according to claim 1 wherein there is provided at least one rear panel member pivotally mounted on a rear end of the frame for pivotal movement between a loading position arranged to lay substantially flat against a floor of the truck bed and a transport position in which the rear panel member is arranged to extend upwardly rearwardly from a portion of at least one of the rear wheels of the all terrain vehicle.

16. The device according to claim 15 wherein there is provided a leg member pivotally coupled to said at least one rear panel member, the leg member being arranged to extend downwardly from a free end of the rear panel member so as to be arranged to support the free end of the rear panel member spaced above the floor of the truck bed in the transport position.

17. The device according to claim 15 wherein there is provided a link member arranged to be coupled between a free end of said at least one rear panel member and the frame at a location spaced forwardly of the rear panel member so as to be arranged to support the free end of the rear panel member spaced above the floor of the truck bed in the transport position.

18. The device according to claim 15 wherein there is provided a handle member pivotally coupled to said at least one rear panel member, the handle member being pivotal between the loading position in which the handle member is arranged to lay substantially flat against the rear panel member and a lifting position in which the handle member is arranged to extend outwardly from the rear panel member so as to be arranged for gripping by a hand of a person.

19. The device according to claim 1 in combination with a personal all terrain vehicle supported on the frame in an inclined position extending at an upward incline from one end of the all terrain vehicle to the other end of the all terrain vehicle.

20. The device according to claim 19 in combination with a truck bed which is shorter in length between a front end and a rear end thereof than the all terrain vehicle, the rear tailgate of the truck bed being closed in the inclined position of the all terrain vehicle.
